(19) United States
(12) Patent Application Publication
(10) Pub. No.: US 2024/0083671 A1
(43) Pub. Date: Mar. 14, 2024

(54) VENTILATION OF FREIGHT CONTAINERS

(71) Applicant: EVAQVENT AB, Sundsvall (SE)

(72) Inventors: Ralf Arne Urban Svedberg, Sundsvall (SE); Boerje Gunnar Johanson, Uppsala (SE)

(21) Appl. No.: 17/754,757

(22) PCT Filed: Oct. 6, 2020
(86) PCT No.: PCT/EP2020/078013

§ 371 Date: Apr. 11, 2022

(30) Foreign Application Priority Data
Oct. 14, 2019 (GB) 1914806.3

(51) Int. Cl. B65D 88/74; B08B 15/00

(52) U.S. Cl. CPC B65D 88/74; B08B 15/00; B65D 2588/12

(57) ABSTRACT

A ventilation suction member (10; 100) comprises a plate body (34) that has a plate surface (36) from which an outer profiled edge (40) extends and defines a plate edge (42). At least a portion (48; 102) of the outer profiled edge (40) is shaped to be analogous to the profile (32) of the air passage interface (30) of a freight container (12) so that the two profiles are able to be positioned in register with one another. The ventilation suction member (10; 100) also includes a seal member (44) for abutment against the freight container (12) in use, and a ventilation passage (46) formed through the plate body (34). The outer profiled edge (40) and the seal member (44) permit suction of the ventilation suction member (10; 100) to the freight container (12).

This invention relates to a ventilation suction member for positioning at an air passage interface of a freight container, a ventilation assembly comprising such a ventilation suction member, a freight container ventilation arrangement comprising such a ventilation assembly and a method of ventilating the inside of a freight container.

A large portion of freight containers hold various hazardous chemicals in the air at high concentrations. The chemicals typically come from volatile residuals from fumigants that are supplied into shipping containers and/or from off-gases from seemingly harmless goods. Such chemicals constitute potential health hazards to workers involved in unpacking or inspecting containers. This puts hundreds of thousands of workers worldwide at risk when entering a container for unpacking or inspection. The problem remains largely unaddressed due to ignorance, lack of suitable field instruments for chemical identification, and lack of easy to use, effective ventilation methods.

There are three known approaches to ventilating a freight container, namely: a) passive ventilation by simply leaving container doors open; b) mechanical blowing ventilation by placing a fan in front of the open doors and blowing air onto the goods, and c) mechanical extraction ventilation by extracting hazardous air from inside the freight container by opening the doors to allow an extraction hose to be fitted inside the container. In particular, the third approach may include inserting a vent pipe on top of the goods as far into the container as possible or clasping or inserting a ventilation console with an extraction port between the container doors. All three current approaches involve opening the doors of the container, thus potentially exposing personnel to harmful chemicals.

There is, therefore, a need for a safer mode of ventilating a freight container prior to unpacking or inspection.

According to a first aspect of the invention there is provided a ventilation suction member for positioning at an air passage interface of a freight container defined by a portion of a wall of the freight container having openings formed therein to permit air to pass between the inside and outside of the freight container, the ventilation suction member comprising:
a plate body having a plate surface from which an outer profiled edge extends defining a plate edge, at least a portion of the outer profiled edge being shaped to be analogous to the profile of the air passage interface so that the two profiles are able to be positioned in register with one another;
a seal member extending around the plate edge for abutment against the freight container in use;
a ventilation passage formed through the plate body to permit the passage of air from one side of the plate body to the other side of the plate body;
wherein the outer profiled edge and the seal member permit suction of the ventilation suction member to the freight container upon extraction of air via the ventilation passage and upon positioning of the plate body at the air passage interface.

The outer profiled edge together with the seal member around the plate edge means that the ventilation suction member is tightly suctioned onto the freight container and held in place without the need for additional attachments. This provides a compact design. It also means that no or minimal hazardous air that is being extracted from inside the freight container can leak out from the ventilation suction member. Since the ventilation suction member is suctioned onto the outside of the freight container, an operative can secure the ventilation suction member and extract hazardous air from the freight container without the need for opening the doors of the freight container. Thus, minimising exposure of the potentially harmful air to the operative.

It will be understood that at least a portion of the profiled edge being shaped to be “analogous” to the profile of the air passage interface means that the two profiles match to allow them to sit in register with one another, while having enough clearance to allow the seal member to sit in between (since, as defined in claim 1, the seal member extends around the plate edge for abutment against the freight container).

It will also be understood that freight containers, depending on where and how they are used, will have set dimensions and design so that they can be stacked and transported effectively. Moreover, freight containers include at least one ventilation opening formed on the wall of the container, thus providing an air passage. The walls of the container will also have a set profile and so the profile of the outer profiled edge of the ventilation suction member can be designed accordingly for a particular type of freight container.

In one embodiment of the invention, the outer profiled edge may include first and second profile portions at opposing ends of the plate body, both the first and second profile portions being analogous to the air passage interface so that a complete seal between the ventilation suction member and the freight container is created upon extraction of air via the ventilation passage.

In such an embodiment, the ventilation suction member itself creates the seal which permits suction of the ventilation suction member to the freight container, thus no additional or external components are required to hold the ventilation suction member in place. In this way, the ventilation suction member can be placed directly in position at the air passage interface of the freight container.

In another embodiment of the invention, the outer profiled edge may include a profile portion analogous to the profile of the air passage interface only at a first end of the plate body so that a gap is created between the ventilation suction member and the freight container at the second opposing end of the plate body, the gap forming an incomplete seal between the ventilation suction member and the freight container upon extraction of air via the ventilation passage thereby permitting lateral movement of the ventilation suction member relative to the freight container.

Such an arrangement means that the ventilation suction member is free to move, e.g. up and down, the wall of the freight container even when air extraction is taking place because the seal between the outer edge of the plate member and the freight container is incomplete (i.e. because of the gap created at the second end of the plate body).

Once a complete seal has been established between the ventilation suction member and the freight container, it is very difficult to reposition the ventilation suction member (even in circumstances where there might be some air leakage between the seal member and the freight container) without turning off the air extraction or introducing some form of vacuum relief valve. Thus, the arrangement outlined above allows an operative to adjust the positioning of the ventilation suction member without having to turn off the air extraction or without the need for additional components such as a vacuum relief valve. This is particularly useful when the air passage interface is positioned at height which is difficult to reach.

Preferably in such an embodiment the second end of the plate body may be shaped so as to abut against a frame member of the freight container when the ventilation suction member is positioned at the air passage interface, the second end of the plate body and seal member at said second end of the plate member thereby completing the seal between the ventilation suction member and the freight container upon said abutment of the second end against the frame member.

In such an arrangement, an existing part of the freight container is used to complete the seal between the ventilation suction member and the freight container, thereby permitting suction of the ventilation suction member to the freight container when the ventilation suction member is positioned at the air passage interface.

As mentioned above, freight containers follow standard sizing and configuration, and so the ventilation holes will typically be positioned at a set distance away from, e.g. the top frame member or roof of a particular type of container. Accordingly, the shape and relative position of the second end of the ventilation suction component can be designed to suit the various configurations of known freight containers so that the second end abuts the frame member of that particular type of freight container to complete the seal.

In any event, the plate member may include a support member extending therefrom to provide support to the seal member.

Providing such a support member helps to prevent the seal member from bending inwards when the air is being extracted through the ventilation passage. Such bending might otherwise compromise the seal between, and thus suction of, the ventilation suction member and the freight container.

The outer profiled edge may extend from the plate surface to create a lip around the plate body, and the portion of the outer profiled edge which is analogous to the profile of the air passage interface may extend from the lip, the lip and the outer profiled edge defining the plate edge.

Alternatively, the portion of the outer profiled edge which is analogous to the profile of the air passage interface may extend from the plate surface, and the plate edge may be defined by the edge of the plate surface and the outer profiled edge.

Either arrangement can be chosen depending on the suitably of the seal that is created by the lip or non-lip plate edge. Moreover, a suitable seal member can be chosen depending on which arrangement is used. For example, a seal member which angles relative to the plate surface can be used for the arrangement with no lip so that a seal is created between the plate body and the freight container; whereas a straight seal member can be used for the arrangement with the lip so that the seal extends in line with the lip and creates a seal to the freight container.

The ventilation suction member may further include an elongate positioning member extending from the plate body and being configured to permit positioning of the ventilation suction member onto the freight container.

Such an elongate positioning member is particularly useful when the air passage interface is at a height out of reach of an operative such that the operative can use the elongate positioning member to position (and, in some instances, move) the ventilation suction member onto the freight container without the need for the use of ladders. Moreover, due to stacking of the freight containers, the height of the air passage interface may even be out of reach with use of a ladder, and so the elongate positioning member together with a ladder may be required.

Optionally the elongate positioning member is fluidly connected to the ventilation passage and is configured to permit the passage of air along its length.

The elongate positioning member being so arranged means that it can also act as an air passage to extract air via the ventilation passage to enable the ventilation suction member to be suctioned to the freight container. Thus, providing a compact design and reducing the weight of the ventilation suction member by reducing the number of components required.

Optionally the elongate positioning member is telescopic.

The elongate positioning member being telescopic allows the length of the positioning member to be adjusted while maintaining the compact nature of the ventilation suction member.

Preferably the ventilation suction member further includes an auxiliary attachment member configured to secure the ventilation suction member to the freight container.

Such auxiliary attachment member provides a back up means of attachment should there be a failure in the suction of the ventilation suction plate to the freight container, e.g. due to a failure of the air extraction or a failure in the seal member, so as to prevent the ventilation suction plate from coming crashing down (likely from a height above head level) from the freight container, which could cause injury to personnel and/or damage to the ventilation suction plate (or the surrounding area).

According to second aspect of the invention there is provided a ventilation assembly, for ventilating the inside of a freight container, comprising:
a ventilation suction member as described hereinabove; and
an air extractor fluidly coupled to the ventilation passage of the ventilation suction member, the air extractor being operable to extract air from inside the freight container via the air passage interface.

The advantages of the ventilation suction member of the first aspect of the invention and its embodiments apply mutatis mutandis to the ventilation assembly of the second aspect of the invention and its embodiments.

The air extractor is operable to extract air at an air flow rate of up to 345 m³/h, preferably up to 300 m³/h, optionally up to 200 m³/h, optionally up to 180 m³/h, optionally between 100 to 200 m³/h, or more optionally between 100 to 150 m³/h.

Preferably, the ventilation assembly further includes an elongate air conduit secured between the ventilation passage and the air extractor to create an air passage therebetween.

The inclusion of such an elongate air conduit means that the air extractor can be positioned away from a working area so that the extracted contaminated air can be expelled at a safe distance away from personnel.

The ventilation assembly may further include a vacuum measurement device to monitor the vacuum pressure at the ventilation suction member.

The use of a vacuum measurement device means that the vacuum pressure can be monitored to indicate when ventilation may need to be aborted or the suction pressure changed. For example, the vacuum pressure can be monitored for it dropping too low which might mean the suction between the ventilation suction member and the freight container could be lost and the ventilation suction member may fall off. Moreover, the vacuum pressure can also indicate where there is a problem with the seal member or where the freight container is taped at the air passage interface.

In the latter regard, many freight containers arrive at their destination with their ventilation holes taped from the inside and it is very difficult to determine that this is the case upon visual inspection from the outside. If this is the case, the vacuum pressure will become excessive which can be monitored by an operative and air extraction ceased.

According to a third aspect of the invention there is provided a freight container ventilation arrangement comprising:
a ventilation assembly as described hereinabove; and
a freight container having an air passage created by openings formed in a portion of a wall of the freight container to define an air passage interface where air is permitted to pass between the inside and outside of the container,
the ventilation suction member of the ventilation assembly being selectively suctioned to the freight container at the air passage interface by operating the air extractor and positioning the ventilation suction member at the air passage interface.

The advantages of the ventilation assembly of the second aspect of the invention and its embodiments apply mutatis mutandis to the freight container ventilation arrangement of the third aspect of the invention and its embodiments.

According to a fourth aspect of the invention there is provided a method of ventilating the inside of a freight container comprising:
providing a plate having a seal member around its outer edge;
extracting air through a passage formed through the plate;
positioning the plate at an air passage interface of a freight container so that at least a portion of the profile of the plate outer edge is in register with an analogous profile of the freight container at the air passage interface, thereby suctioning the plate to the freight container;
continuing to extract air through the passage of the plate so that air within the freight container is removed from the freight container via openings formed in a wall of the freight container at the air passage interface.

The advantages of the first to third aspects of the invention and its embodiments apply mutatis mutandis to the method of the fourth aspect of the invention and its embodiments.

In one embodiment of the invention, the step of positioning the plate at an air passage interface of a freight container includes positioning the plate directly onto the freight container at the air passage interface, wherein the plate creates a complete seal between the plate and the freight container, thereby suctioning the plate to the freight container.

In such an embodiment, the plate itself creates the seal which permits suction of the plate to the freight container, thus no additional or external components are required to hold the plate in place. In this way, the plate can be placed directly in position at the air passage interface of the freight container.

In another embodiment of the invention, the step of positioning the plate at an air passage interface of a freight container includes positioning the plate onto the freight container at a position other than that of the air passage interface, wherein the plate creates an incomplete seal between the plate and freight container, and further includes the step of:
sliding the plate along the wall of the freight container towards the air passage interface until it abuts a frame member of the freight container, abutment to the frame member completing the seal between the plate and the freight container, thereby suctioning the plate to the freight container.

In such an embodiment, the plate is free to move, e.g. up and down, the wall of the freight container even when the air extraction is taking place because the seal between the plate and the freight container is incomplete. As such, the plate can be positioned onto the freight container at a point away from the air passage interface and then moved into position at the air passage interface. This is particularly useful when the air passage interface is positioned at height which is difficult to reach.

Moreover, an existing part of the freight container, i.e. the frame member, is used to complete the seal between the plate and the freight container, thereby permitting suction of the plate to the freight container when the plate is positioned at the air passage interface.

Optionally, the method further includes the step of:
measuring the vacuum created at the plate and altering operation of air extraction if the vacuum measurement reaches a predetermined level.

As described above in relation to the second aspect of the invention, measuring the vacuum pressure means that it can be monitored to indicate when ventilation may need to be aborted or the suction pressure changed.

The method may further include the step of:
opening the freight container doors only after a predetermined amount of time of air extraction.

Such a step means that an operative is exposed to the air inside the freight container when it is at a safe level. The amount of time needed to reach a safe level is difficult to predict beforehand, as it depends on a number of factors such as the volume of the freight container, the free space inside the freight container, the flow rate of the air extractor, the way the container is packed (tightly or stacked, palletized goods), the type of goods and the ambient temperature. However, with growing experience based on chemicals measurements while noting the above factors, time predictions will become more reliable. In the development of this extraction device the target was to reach 10% of arrival concentrations within 4 hours in a 40-foot container.

Preferred embodiments of the invention will now be described, by way of non-limiting examples, with reference to the accompanying drawings in which:

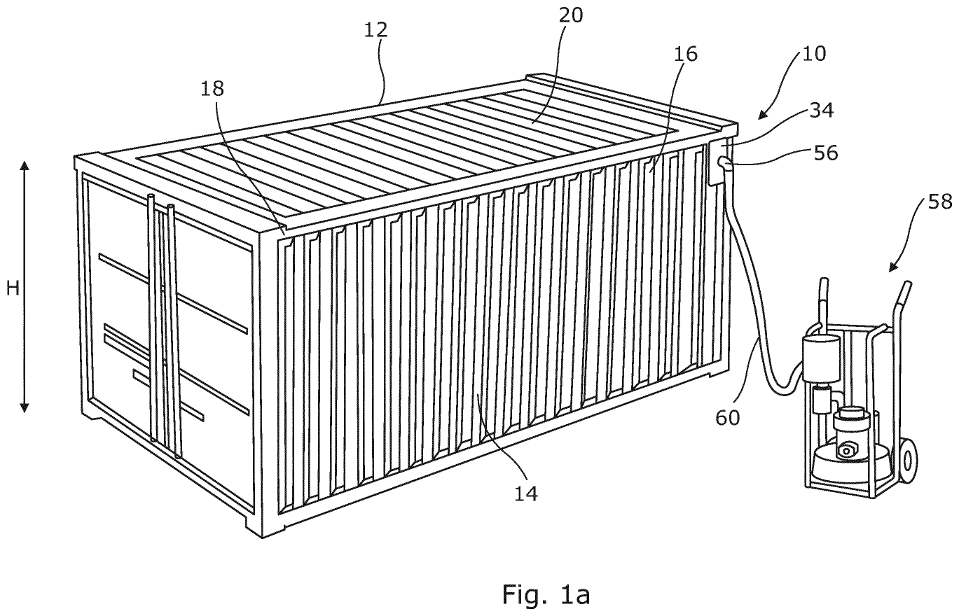

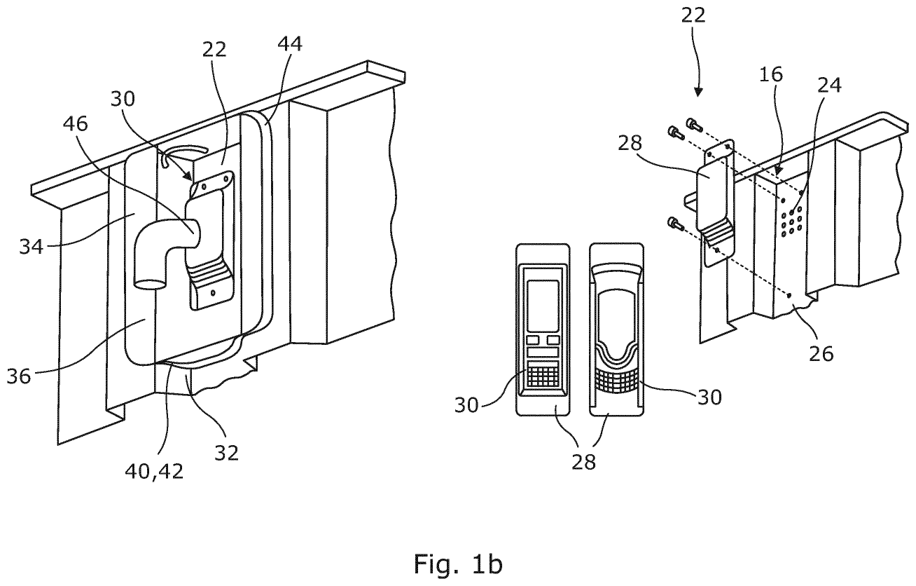

FIG. 1a shows a ventilation suction member according to a first embodiment of the invention in use with a freight container;

FIG. 1b shows an air interface passage of the freight container shown in FIG. 1a;

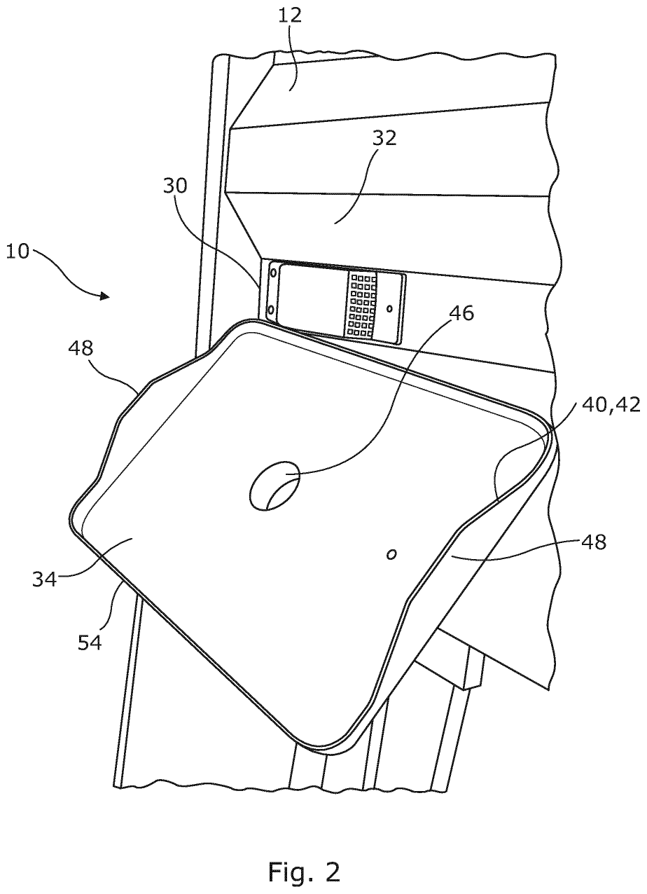

FIGS. 2 to 5 show the ventilation suction member of FIG. 1a in more detail;

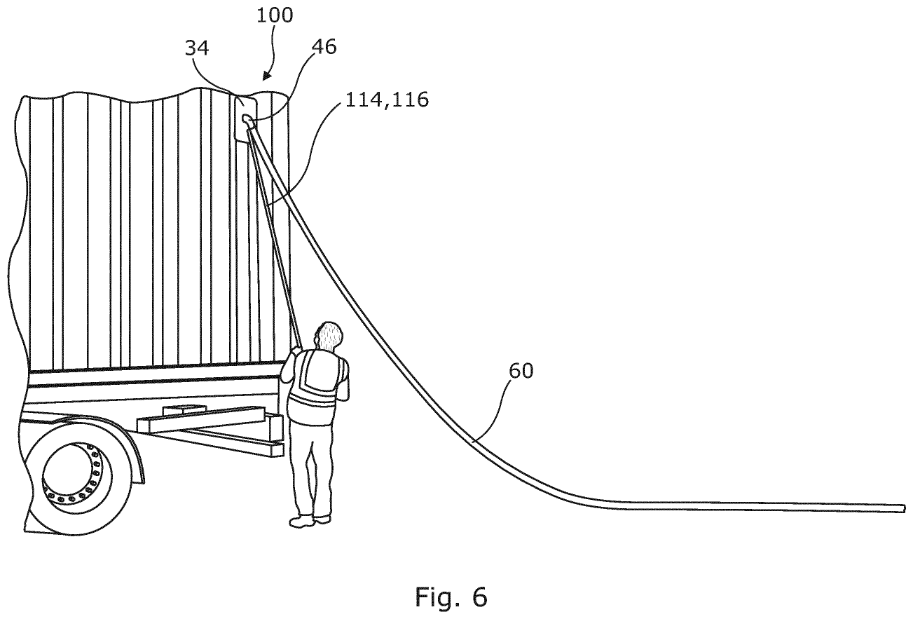

FIG. 6 shows a ventilation suction member according to a second embodiment of the invention in use with a freight container;

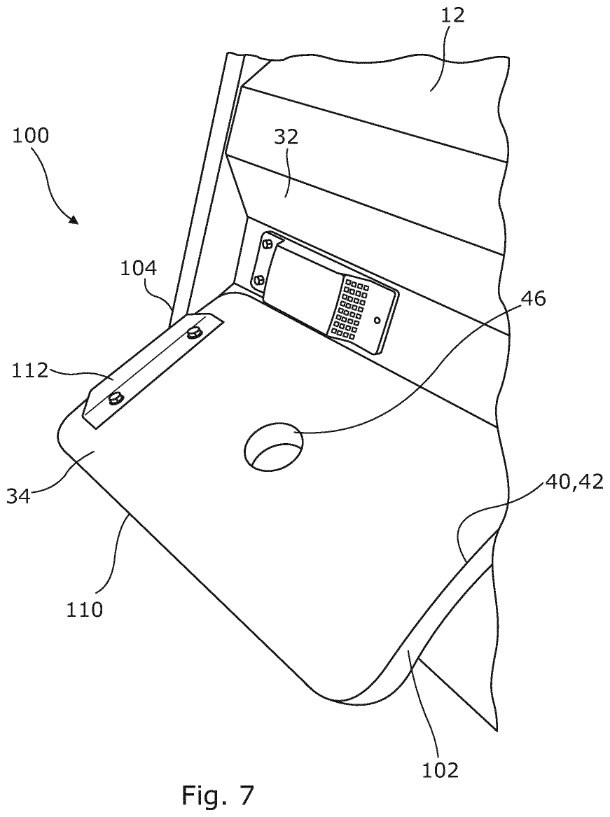

FIGS. 7 to 10 show the ventilation suction member of FIG. 6 in more detail;

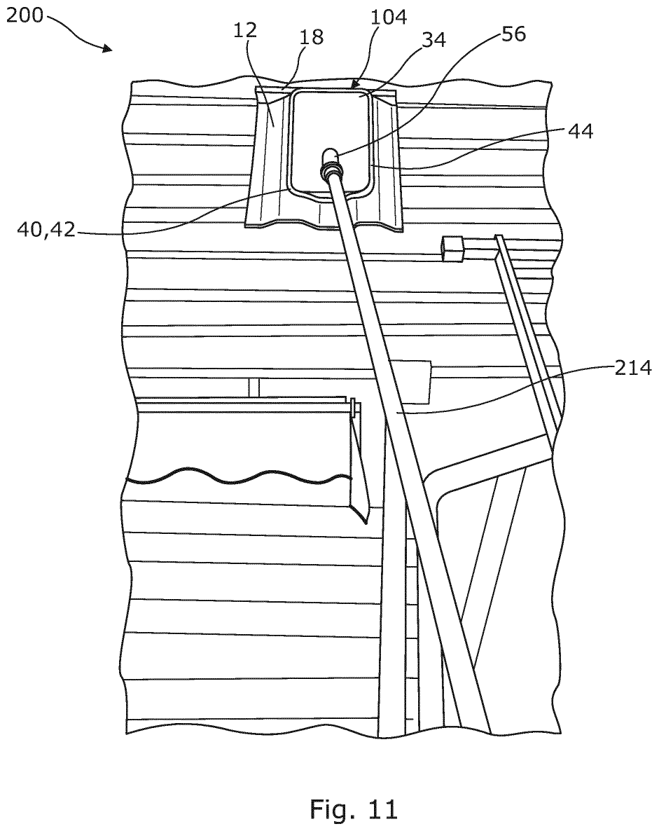

FIG. 11 shows a ventilation suction member according to a third embodiment of the invention in use with the relevant portion of a freight container attached to a wall for experimental purposes;

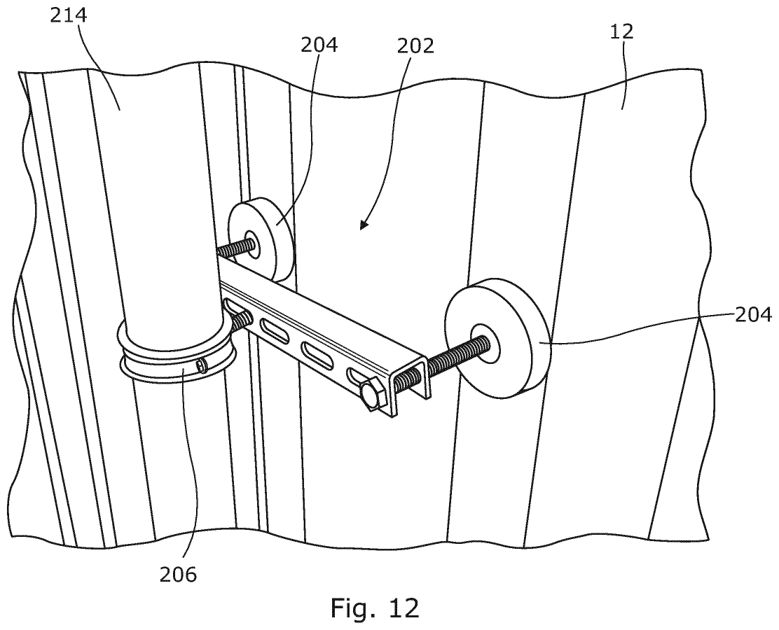

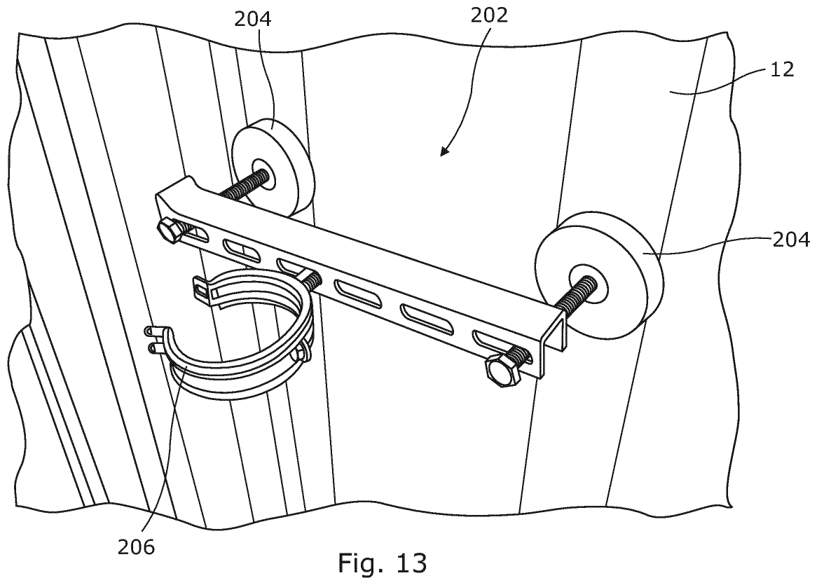

FIGS. 12 and 13 show safety attachments of the ventilation suction member of FIG. 11; and

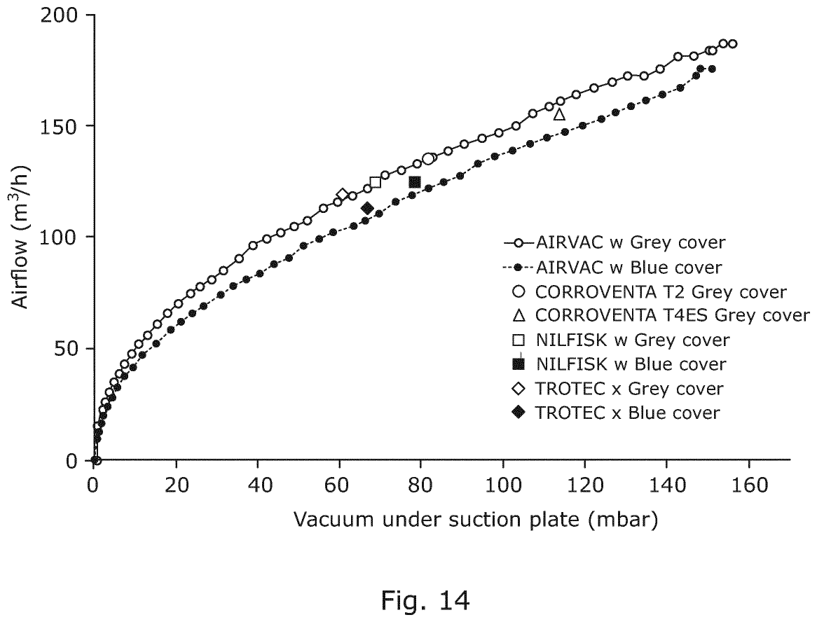

FIG. 14 is a graph from the experimental data showing the recorded flow rate and achieved vacuum with five different extraction units and two types of vent covers.

A ventilation suction member according to a first embodiment of the invention is shown in FIGS. 1a to 5 and is designated generally by reference numeral 10.

The ventilation suction member 10 is shown suctioned to a freight container 12. The design of ISO containers is governed by several international standards, including ISO 668 (ISO, 2013) which includes the dimensions of the containers. The freight container 12 shown is such a standard ISO container and, as such, includes 2 mm steel sheet walls 14 which have a series of trapezoidal profile indentations 16. Each indentation 16 extends up the height H of the freight container 12.

The freight container 12 also includes a roof member 18 extending along the top outer edge of the container 12 to help secure the wall 14 to a roof 20 of the container 12. The roof member 18 therefore extends substantially perpendicular to the trapezoidal profile indentations 16.

As shown in more detail in FIG. 1b, the freight container also includes, what is commonly referred to as, “a corner ventilator” or “vents” 22. The design of the corner ventilators 22 is governed by basic requirements set out in Annex 2, article 2.2.1(c) of the TIR Convention 1975 (European Council, 2009).

In this example, the corner ventilator 22 is made up of a lattice of openings (in this case, circular holes) 24 that are formed through an innermost surface 26 of one of the trapezoidal profile indentations 16. The lattice of holes 24 is typically located at a top corner of the freight container 12.

In this example, the lattice is made up of nine 10 mm diameter holes 24 with a combined surface area of approximately 7 cm².

A plastic vent cover 28 is fitted over the holes 24. The vent cover 28 has a grid of small holes 30 to prevent insects from entering, and a water trap on the inside. Two types of common vent covers 28 are shown in FIG. 1b, representing high and low flow restrictions.

The combined surface area of the holes 30 in the vent cover 28 typically range from 4 to 5 cm², thus creating a greater flow restriction than the holes in the container wall 14.

The portion of the container wall 14 which includes the corner ventilator 22 defines an air passage interface 30 which permits the passage of air between the inside and outside of the freight container 12. As indicated, the air passage interface 30 includes a profile 32 that is trapezoidal in shape.

It will be understood that some freight containers 12 may differ in design to that shown in FIGS. 1a and 1b and in which case the design of the ventilation suction member 10, as described below, would be altered to be suitable for those differences.

Returning to the ventilation suction member 10, it includes a plate body 34 that has a plate surface 36. An outer profiled edge 40 extends from the plate surface 36 which defines a plate edge 42. At least a portion of the outer profiled edge 40 is shaped to be analogous to the profile 32 of the air passage interface 30 so that the two profiles can be positioned in register with one another (this is described and shown in more detail below).

The ventilation suction member 10 also includes a seal member 44 that extends around the plate edge 42 and which abuts against the freight container 12.

Furthermore, the ventilation suction member 10 includes a ventilation passage 46 formed through the plate body 34 to permit the passage of air from one side of the plate body 34 to the other.

Turning now to FIG. 2, the underside of the plate body 34 is shown without the seal member 44. As can be seen, the outer profiled edge 40 includes first and second profile portions 48 at opposing ends of the plate body 34. Both of the profile portions 48 are analogous to the profile of the air passage interface 30. In this example, both of the profile portions 48 are trapezoidal in shape and extend from the plate body 34 so that they negatively match the trapezoidal indent profile 32 of the air passage interface 30.

In this example, the plate body 34 is a 2 mm thick flat steel plate with a width of approximately 30 cm and length of approximately 50 cm.

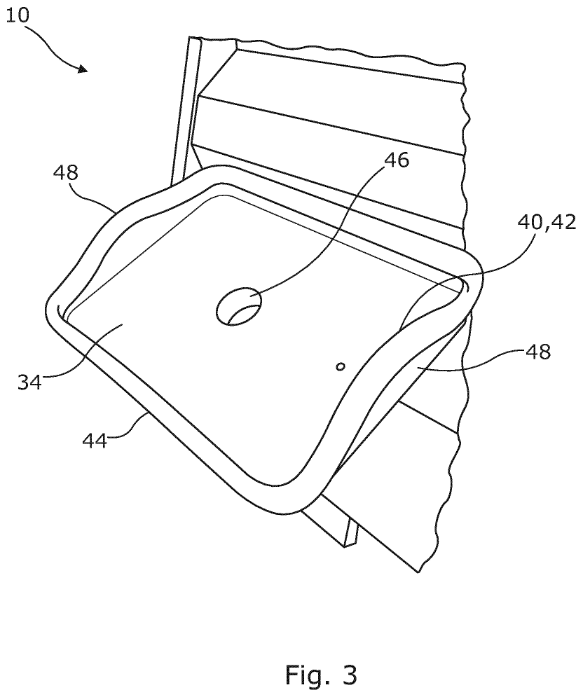

Moving onto FIG. 3, the underside of the plate body 34 is shown with the seal member 44 which is secured around the entire plate edge 42. It can be seen that the plate body 34 has rounded corners which allows a single seal member 44 to loop around the entire plate edge 42. The inventors found that sharp corners make it almost impossible to attach a commercially-available rubber seal. It is envisaged that a specially moulded seal member 44 could be manufactured to fit around any shaped corner. In any event, the seal member must be easy to replace since it will be exposed to wear and tear.

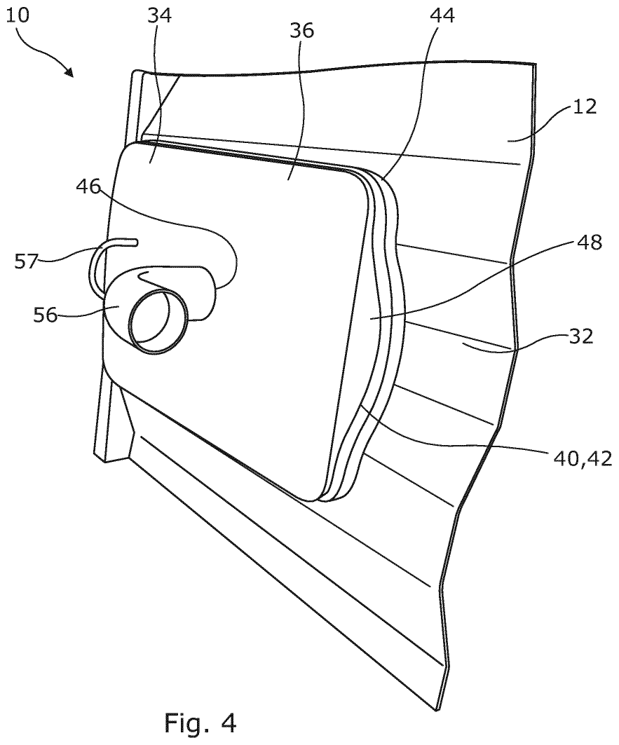

FIG. 4 shows the ventilation suction member 10 in-situ at the air passage interface 30 of the freight container 12. As can be seen, the seal member 44 creates a seal between the plate edge 42 and the freight container 12. Moreover, since the outer profiled edge 40 has first and second profile portions 48 that are analogous to the profile of the air passage interface 30, a complete seal is created around the air passage interface 30 by the ventilation suction member 10 itself (i.e. no other external components are required to create the seal).

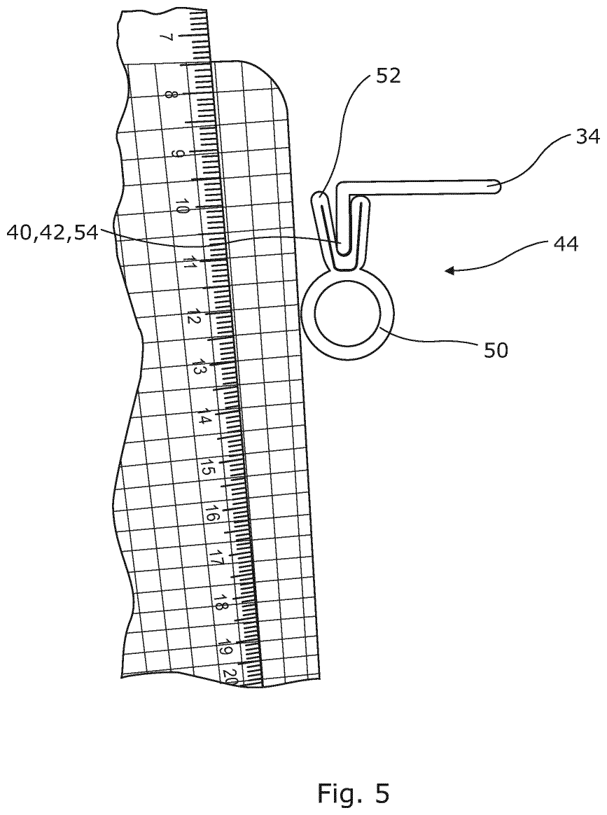

FIG. 5 shows the seal member 44 in more detail. The seal member 44 includes a seal member portion 50, for abutment against the freight container 12, and an attachment portion 52, for securing the seal member 44 to the plate body 34. In this example, the seal member portion 50 extends from, and is in line with, the attachment portion 52. In this way, the seal member 44 is “straight”. The seal member 44 is rubber but may be any suitable material. Moreover, the seal member portion 50 and the attachment portion 52 may differ in material.

In other embodiments, and as described below in relation to the second embodiment of the invention, the seal member 44 may be such that the seal member portion 50 is angled relative to the attachment portion 52. The configuration of the seal member 44 can be chosen depending on the configuration of the plate edge 42 so that a seal is created between the plate edge 42 and the freight container 12.

In this embodiment, and as shown more clearly in FIG. 2, the outer profiled edge 40 extends from the plate surface 36 to create a lip 54 around the plate body 34. The first and second profile portions 48 each extend from the lip 54. Therefore, the plate edge 42 consists of the lip 54 and the profile portions 48.

In this embodiment, the lip 54 extends from the plate surface 36 at 90°, but in other embodiments it may extend at a different angle. The lip 54 also extends around the entire perimeter of the plate surface 36, but in other embodiments it may instead only extend partially around such that the plate edge 42 consists of the lip portions 54, the profile portions 48 and the flat edge of the plate surface 36.

Since the lip 54 is at 90° in this embodiment, the “straight” seal member 44 is used to create a seal between the lip 54 and the freight container 12. However, if the lip 54 was at a different angle then a different seal member 44 may be chosen, i.e. one in which the seal member portion 50 is angled relative to the attachment portion 52 so that a seal is created between the lip 54 and the freight container 12.

As shown in FIG. 4, the ventilation suction member 10 also includes a ventilation guide 56 positioned on the plate surface 36 at the ventilation passage 46. The ventilation guide 56 in this example is in the form of a tube that extends from the plate surface 36 and bends downwards (i.e. towards the floor of the freight container 12 when the ventilation suction member 10 is in-situ).

Although not shown in the figures, the ventilation suction member 10 includes an auxiliary attachment member that is configured to secure the ventilation suction member 10 to the freight container 12. The auxiliary attachment member may be in the form of a strap which is hooked around the corner of the freight container 12. The auxiliary attachment member may instead take the form of strong magnets.

As also shown in FIG. 4, the ventilation suction member 10 includes a handle 57 to allow an operative to carry and position the ventilation suction member 10. The handle 57 also provides an anchor for attaching the auxiliary attachment member (e.g. a strap) to the ventilation suction member 10.

Returning to FIG. 1a, when the ventilation suction member 10 is in use, the ventilation passage 46, i.e. via the ventilation guide 56, is connected to an air extractor 58. The air extractor 58 is operated to extract air from inside the freight container 12 via the air passage interface 30. The air extractor 58 include an elongate conduit 60 which is flexible (e.g. like a hose) that is secured to the ventilation guide 56 and defines an air passage.

Although not shown in the figures, a vacuum measurement device may be used which monitors the vacuum pressure at the ventilation suction member 10. The measurement device can be positioned anywhere along the elongate air conduit 60 of the air extractor 58 (i.e. anywhere between the extractor unit and underneath the ventilation suction member 10), and would preferably display the monitored pressure at ground level (i.e. so that an operative can easily read the pressure).

Moreover, an additional vacuum measurement device may be used to monitor the vacuum pressure inside the freight container so as to monitor whether the pressure may jeopardize the structural integrity of the container, which may cause collapse of the container. Such an additional vacuum measurement device may be inserted between the door seals of the closed doors of the freight container.

In use, an operative switches on the air extractor 58 so that air is vacuumed in through the ventilation passage 46 and along the elongate conduit 60.

The operative then uses the handle 57 and/or the ventilation guide 56 to position the ventilation suction member 10 over the air passage interface 30. The operative may need a ladder to reach the height of the air passage interface 30 (which might typically be around 4 m off the ground).

When the operative places the ventilation suction member 10 onto the freight container 12, the seal member 44 and the analogous profiles creates a seal around the plate edge 42. Due to operation of the air extractor 58, a vacuum is created under the ventilation suction member 10 such that a suction seal is created which holds the ventilation suction member tightly in place on the freight container 12.

A wireless remote switch of the air extractor 58 will allow the operative to turn on and off, or even select fan speed, of the air extractor 58 while in the process of positioning the ventilation suction member 10 to the container 12. If the ventilation suction member 10 is suctioned to the container 12 in an unfavorable position, the operative can turn off the extraction fan or reduce the fan speed to facilitate repositioning of the ventilation suction member 10.

The air extractor 58 extracts the hazardous air from inside the freight container 12. Although not shown, the air extractor 58 includes an exhaust hose which routes the extracted air away from the work area to dispose of the hazardous extracted air. Meanwhile, clean ambient air enters the freight container 12 via leakage points such as untight floorboards, other open vents or via untight door seals. The clean ambient air replaces the hazardous air. The air extractor is operated for a predetermined amount of time until the air inside the freight container 12 is at a safe level. Then, the doors of the freight container 12 can be opened.

The inventors found in their studies that leakage around the floorboards constitutes the principal route of air exchange with ambient air, which was a surprising discovery. This means that ventilation of all parts of the container 12 can be achieved since the clean ambient air is able to enter through the floor to replace the extracted hazardous air.

A ventilation suction member according to a second embodiment of the invention is shown in FIGS. 6 to 10 and is designated generally by reference numeral 100.

The ventilation suction member 100 of the second embodiment shares many features of the ventilation suction member 10 of the first embodiment, and like features share the same reference numeral.

As shown in FIG. 7, the ventilation suction member 100 of the second embodiment differs from the ventilation suction member 10 of the first embodiment in that the outer profiled edge 40 includes a profile portion 102 that is analogous to the profile of the air passage interface 30 at only one end of the plate body 34. Therefore, there is only a single matching profile which results in a gap being formed between the ventilation suction member 100 and the freight container 12 at the second opposing end 104 of the plate body 34.

In this example, the single profile portion 102 is trapezoidal in shape and extends from the plate body 34 so that it negatively matches the trapezoidal indent profile 32 of the air passage interface 30.

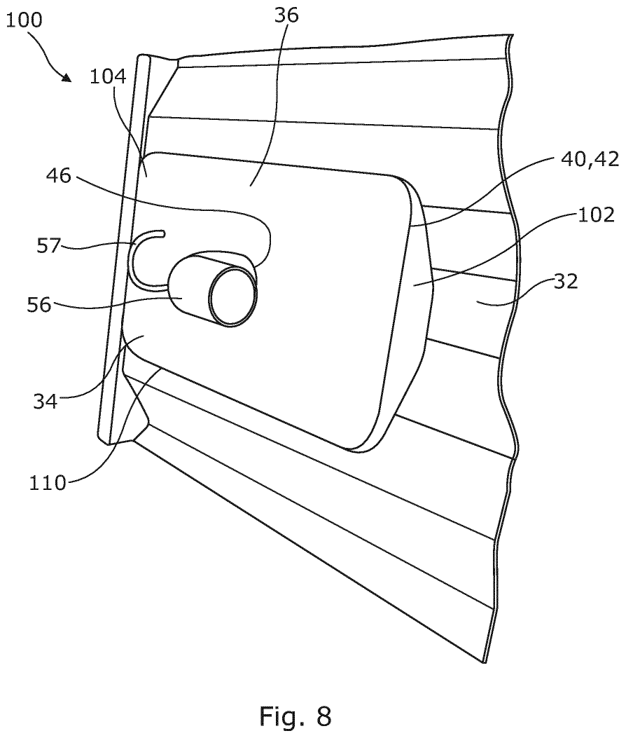

FIG. 8 shows the ventilation suction member 100 in-situ at the air passage interface 30 of the freight container 12. Although no seal member 44 is shown in FIG. 8, it will be understood that the seal member 44 would create a seal between the plate edge 42 and the freight container 12. However, the seal would be incomplete at the second end 104 of the plate body 34 because there is no analogous profile at that end. During use, this would have the practical effect of the ventilation suction member 100 being able to be moved along the freight container surface since a suction seal will not have been created.

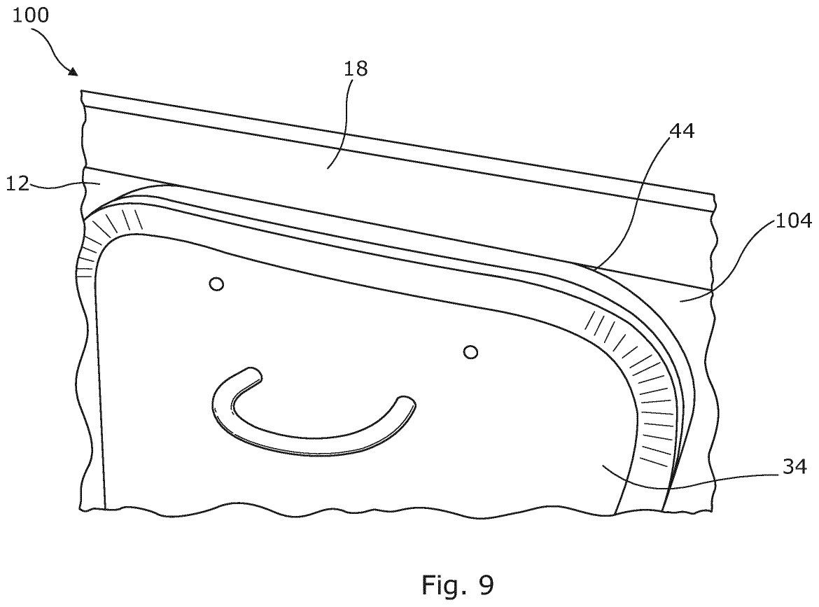

However, turning to FIG. 9, when the ventilation suction member 100 is moved over the air passage interface 30, the second end 104 of the plate body 34 (more particularly, the seal member 44 at that end) abuts against the top horizontal frame member 18 of the freight container 12, thus completing the seal.

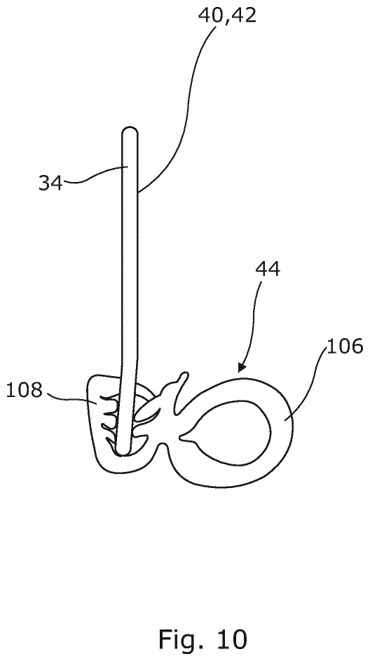

FIG. 10 shows the seal member 44 in more detail. In this embodiment, the seal member 44 includes a seal member portion 106 that extends substantially perpendicular to an attachment portion 108. As such, the seal member portion 106 and the attachment portion 108 are positioned side-by-side. In this way, the seal member 44 is “angled”. In other embodiments, the seal member portion 106 may be angled relative to the attachment portion 108 at an angle other than 90°.

In other embodiments, and as described above in relation to the first embodiment of the invention, the seal member 44 may be such that the seal member portion 106 extends in line with the attachment portion 108. The configuration of the seal member 44 can be chosen depending on the configuration of the plate edge 42 so that a seal is created between the plate edge 42 and the freight container 12.

The ventilation suction member 100 also differs in that the profile portion 102 extends from the plate surface 36 such that the plate edge 42 is defined by the edge 110 of the plate surface 36 itself and the profile portion 102. In other words, there is no lip present like that shown in the first embodiment.

Since there is no lip in this embodiment, the perpendicular seal member 44 is used to create a seal between the flat plate edge 42 and the freight container 12.

The ventilation suction member 100 further includes a support member 112 located at the second end 104 of the plate body 34, as shown in FIG. 7. The support member 112 extends from the underside of the plate body 34 adjacent to the plate edge 42 at the second end 104 so as to provide support to the seal member 44 (i.e. to prevent it from bending inwards through the gap when air is being extracted).

In this embodiment, the support member 112 is a L-shaped plate that is secured to the underside of the plate body 34. In other embodiments, the support member 112 may be formed by a lip extending from the plate body 34 such that it is integrally formed with the plate body 34.

Although not shown in the figures, the ventilation suction member 100 may include another support member located at the first end of the plate body 34 (i.e. the end opposite the second end 104). The support member at the first end may take any suitable form to prevent the seal member 44 from bending inwards without compromising on the matching profiles of the ventilation suction member 100 and the freight container 12.

Moreover, although not shown in the figures concerning the first embodiment of the ventilation suction member 10, it also may include one or more support members located at either end of the plate body 34 (i.e. at either end where the first and second profile portions 48 are located).

As shown in FIG. 6, the ventilation suction member 100 further includes an elongate positioning member 114 in the form of a telescopic pole 116. The telescopic pole 116 is selectively secured to the plate body 34. It may instead be permanently secured thereto.

In use, as with the first embodiment of the invention, an operative switches on the air extractor (not shown in FIG. 6) so that air is vacuum in through the ventilation passage 46 and along the elongate conduit 60.

This time, the operative uses the telescopic pole 116 to place the ventilation suction member 100 onto the freight container 12 at a position underneath the air passage interface 30. Since the second end 104 of the plate body 34 creates a gap between the plate body 34 and the freight container 12, a suction seal is not created and the plate body 34 can be moved. In particular, the operative uses the pole 116 to move the ventilation suction member 100 upwards along the trapezoidal indentation of the freight container 12 towards the air passage interface 30.

Once the seal member 44 at the second end 104 of the plate body 34 abuts the top frame member 18 of the freight container 12, a complete seal is formed at the plate edge 42. Due to operation of the air extractor, a vacuum is created under the ventilation suction member 100 such that a suction seal is created which holds the ventilation suction member 100 tightly in place on the freight container 12.

As before, the air extractor extracts the hazardous air from inside the freight container 12. Meanwhile, clean ambient air enters the freight container 12 via leakage points such as the floor of the container 12. The clean ambient air replaces the hazardous air. The air extractor is operated for a predetermined amount of time until the air inside the freight container 12 is at a safe level. Then, the doors of the freight container 12 can be opened.

In an alternative embodiment, the operative places the ventilation suction member 100 onto the freight container 12 at a position above the air passage interface 30, i.e. rests it on the top frame member 18 of the freight container 12. Then, the operative uses the pole 116 to slide the ventilation suction member 100 downwards so that the plate body 34 is covering the air passage interface 30 and the seal member 44 at the second end 104 of the plate body 34 abuts the top frame member 18 of the freight container. In this embodiment, the support member 112 would not be present since it would catch on the top frame member 18 as the ventilation suction member 100 is slip down.

A third embodiment of a ventilation suction member 200 is shown in FIGS. 11 to 13, which shares many features of the second embodiment of the invention (such features are illustrated using the same reference numerals).

The third embodiment of the ventilation suction member 200 differs from that of the second embodiment in that the elongate positioning member 214 also acts as an air passage to the air extractor (not shown in FIGS. 11 to 14) to permit suction. As such, the elongate conduit 60 shown in the second embodiment is not required. Instead, the elongate positioning member 214 (which is used to position the ventilation suction member 200 onto the freight container 12) is also integrated with the air extractor. In this way, the elongate positioning member is an integrated suction pole 214.

In the third embodiment, there is a mount arrangement 202 (as shown in FIGS. 12 and 13) included which secures the integrated suction pole 214 to the freight container 12 to hold the suction pole 214 and ventilation suction member 200 in place should the suction seal fail (i.e. to prevent the two components from crashing down in the event of such failure).

The mount arrangement 202 includes magnets 204 which interact with the freight container 12, and a fold-over snap lock 206 which receives and locks onto the suction pole 214.

FIG. 11 shows a portion of the freight container 12 attached to the wall of a building, which was used for experimental purposes.

Experimental Data

Basic Principles

The ventilation approach explored in the present study is based on extraction of the polluted air inside the container via the existing top corner ventilators while the container doors remain closed. To this end, a specially designed suction plate connected to an extraction fan is positioned over one of the front corner ventilators of the container. The contaminated container air is replaced by clean ambient air entering via remaining ventilators and untight doors and floor. The extracted air is led away from the container to avoid recirculation of contaminants.

The ISO Dry Cargo Shipping Container

The design of ISO shipping containers is governed by several international standards, including ISO 668 (ISO, 2013) which sets out the dimensions and ratings of containers. The common dry cargo containers are built around a frame onto which the walls and roof are fitted with trapezoidal profile weathering 2 mm steel sheets. The double wing doors at the rear end of the container are equipped with rubber gaskets to provide a seal between doors and against the doorsill, corner posts and door header. The floor is predominantly made from 25-28 mm plywood boards and screwed to steel cross members. A sealant is applied to prevent leakage between boards and frame. The containers are made to be spray safe during ocean transport. The traditional dry cargo containers come in lengths between 8 and 45 feet and in standard height and high cube. The most common sizes used for shipping are the 20 foot (approximate volume 33 m³) and the 40 foot (67 m³, high cube 76 m³) versions. Although termed unventilated, the dry cargo containers are fitted with two or four corner ventilators (occasionally more) at the top of the side walls, mainly to prevent pressure build-up in case of a dramatic temperature increase or release of gaseous compounds during transport as well as providing some protection from water condensation.

Corner Ventilator Design

The design of the corner ventilators is governed by basic requirements set out in Annex 2, article 2.2.1(c) of the TIR Convention 1975 (European Council, 2009). Each ventilator consists of a lattice of nine 10 mm diameter holes with a combined surface area of approximately 7 cm². A plastic vent cover is fitted over the holes. The vent covers have a grid of small holes to prevent insects from entering, and a water trap on the inside. The combined surface area of the holes in the grid typically range from 4 to 5 cm², thus creating a greater flow restriction than the holes in the wall.

Extraction Fan Units

Four commercial extraction units were tested. Two versions of a turbine model Corroventa T2 (1100 W, 260 mbar, 180 m³/h) and Corroventa T4ES, (1800 W, 260 mbar, 300 m³/h, Corroventa Avfuktning A B, Bankeryd, Sweden), a small side channel blower Trotec VE4, (1100 W, 175 mbar, 150 m³/h, Trotec GmbH & Co, Heinsberg, Germany); a wet/dry vacuum cleaner Nilfisk Model Multi II 30T (1400 W, 210 mbar, flow rate not specified, Nilfisk A/S, Brøndby, Denmark). In addition, a special high-performance extraction unit was assembled for the purpose of this study (Airvac Luft & Vacuumteknik A B, Stockholm, Sweden). The unit was built around a side channel blower type EKB HB 2613-220T (240V, 13A, EKB Produkter A B, Klippan, Sweden) fitted with a frequency inverter (Type ESV222NO2SFC, Lenze, Uxbridge, MASS, USA). The output power was adjusted in 0.1% increments between 1-60% of the nominal maximum flow rate of 345 m³/h and maximum vacuum −200 mbar. An adjustable in-line vacuum relief valve protected the unit from overheating if connected to a clogged or taped corner ventilator. An in-line particle filter protected the fan from accidental contamination. The flexible suction hoses used were up to 20 meters long (63 mm inner diameter, wire reinforced).

Suction Plate

A specially designed suction plate was manufactured. It was positioned over the corner ventilator cover as shown in FIG. 1a. After trying several prototypes, the version that provided the easiest handling and best seal was a 2 mm thick flat steel suction plate, (˜30×50 cm) with an edge shaped to match the trapezoidal profile of the container wall. A thick soft rubber channel seal was fixed around the edge. Once the extraction unit was started, the suction plate could be positioned in place and the vacuum created a tight seal and strong hold. To prevent personal and material injury, in case of electrical failure and vacuum loss, the suction plate was secured by a strap to the upper container corner casting. A prototype with the suction plate mounted on a telescopic pole was developed to allow positioning from the ground without the use of stepladders or work platforms.

Vacuum Measurements

The negative pressure reached inside the containers during ventilation was monitored during ventilation for two purposes, to estimate the tightness of the container and to warn for excess vacuum that could jeopardize the structural integrity. A manometer, either a 0-25 mbar analogue manometer (Svenska Manometerfabriken A B, Leksand, Sweden) or a U-tube manometer with ethanol indicator fluid, was connected to a probe inserted between container doors. In this study, a maximum vacuum of 15 mbar inside the container was considered acceptable. In addition, a 0-250 mbar manometer (Svenska Manometerfabriken A B) was used to monitor the vacuum created under the suction plate.

Air Flow Measurements

The flow rate through the ventilator was measured with a digital wing anemometer (KIMO LV 110, KIMO Instruments, Montpon, France). A small connector head was taped tight in place over the ventilator opening at the inside of the container wall. A 3 m flexible hose was attached and finished off with a 1.5 m straight vent duct (100 mm diameter) to allow for laminar flow. The wing anemometer was taped over the inlet of the duct. Flow rates were read as 30 s averages.

Container Tightness

We observed a slight, but visible, deflection of the roof on some containers when ventilation was started. We therefore tested randomly selected 20 foot containers for their structural tightness. An extraction of 100 m³/h was applied through one ventilator while, all other ventilators being sealed with duct tape, and the achieved vacuum inside was measured.

Laboratory Tests

A section of a scrap container wall was cut out and moved to the laboratory. An exact copy of a ventilator assembly, including the nine holes and the vent cover was assembled. Onto this, the suction plate and air flow meters were installed. Vacuum and flow rate measurements were carried out in parallel using the previously described five extraction units and two vent covers.

Field Tests

Several visits were made to distribution centers and container terminals to test the practical handling aspects, including mounting of the suction plate on the ventilator. Noise vs. flow rate and vacuum vs. container age measurements were made on field containers.

Results

Five different extraction units and two different vent covers were tested. By using increasing power settings on the high-performance unit, continuous reference curves of achieved flow rate as a function of vacuum under the suction plate, were generated (FIG. 14). A maximum of 186 m³/h was achieved using the Airvac unit at 55% capacity, the limit for a13A fuse (at 230 V). All tested extraction units exceeded the target of providing a flow rate through the ventilator of at least 100 m³/h. At this flow, 55 mbar vacuum was measured under the suction plate using the more restrictive blue vent cover, while 42 mbar was obtained with the less restrictive grey version.

The projected surface area of the suction plate is 0.15 m², thus at 42-55 mbar vacuum creates a total force of 630-825 N (corresponding to 65-85 kg) that keeps the suction plate firmly in place. When gradually lowering the flow, the plate fell off at around 7 mbar.

No correlation was found between container age and structural tightness in the 20 tested. One of the containers, less than a year old, initially showed a vacuum of 0.8 mbar with all free vents taped, thus, indicating a substantial residual leakage. After taping the seemingly tight gaps between adjoining plywood floorboards from the inside, the vacuum increased to 10 mbar. This suggests that leakage around the floorboards is a major supplier of replacement air.

Summary of Results

The extraction units achieved flow rates through the ventilator of 100 m³/h or more, with a specially designed high-performance unit reaching nearly 200 m³/h. At 100 m³/h, the vacuum under the suction plate ranged from 42 to 55 mbar, depending on the vent cover type. This vacuum, and the relatively large area of the plate of ˜1500 cm², created a total atmospheric pressure on the suction plate corresponding to 65-85 kg, which is more than needed to hold the plate securely in place. Vacuum measurements inside containers before and after duct tape sealing of unused ventilators, door seals and floorboard joints showed that the extracted air is replaced not only via ventilators and leakage around door seals but to a large extent via loose floorings. The vacuum in different containers varied considerably, indicating various degrees of leakage, but did not correlate with the age of the container.

The ventilation method developed herein allows for convenient and controlled ventilation of risk containers at a low cost. The ventilation can be applied keeping the container closed, this greatly reduces the risk of contamination of immediate work areas compared to methods where the door(s) have to be opened.

1. A ventilation suction member, where in use the ventilation suction member is positioned at an air passage interface of a freight container defined by a portion of a wall of the freight container having openings formed therein to permit air to pass between an inside and an outside of the freight container, the ventilation suction member comprising:
a plate body having a plate surface from which an outer profiled edge extends defining a plate edge, at least a portion of the outer profiled edge being shaped to be analogous to a profile of the air passage interface so that in use the two profiles are able to be positioned in register with one another;
a seal member extending around the plate edge for abutment against the freight container in use;
a ventilation passage formed through the plate body to permit passage of air from one side of the plate body to an other side of the plate body;
wherein in use the plate body is positioned at the air passage interface and air is extracted via the ventilation passage, an extraction of air creating suction of the ventilation suction member to the freight container such that the outer profiled edge and the seal member create a seal between the ventilation suction member and the freight container and the suction holds the ventilation suction member in position against the freight container wall.

2. The ventilation suction member according to claim 1 wherein the outer profiled edge includes first and second profile portions at opposing ends of the plate body, both the first and second profile portions being analogous to the air passage interface so that a complete seal between the ventilation suction member and the freight container is created upon extraction of air via the ventilation passage.

3. The ventilation suction member according to claim 1 wherein the outer profiled edge includes a profile portion analogous to the profile of the air passage interface only at a first end of the plate body so that a gap is created between the ventilation suction member and the freight container at a second opposing end of the plate body, the gap forming an incomplete seal between the ventilation suction member and the freight container upon extraction of air via the ventilation passage thereby permitting lateral movement of the ventilation suction member relative to the freight container.

4. The ventilation suction member according to claim 3 wherein the second opposing end of the plate body is shaped so as to abut against a frame member of the freight container when the ventilation suction member is positioned at the air passage interface, the seal member at the second opposing end of the plate body thereby completing the seal between the ventilation suction member and the freight container upon said abutment of a second end against the frame member.

5. The ventilation suction member according to claim 1 wherein the plate body includes a support member extending therefrom to provide support to the seal member.

6. The ventilation suction member according to claim 1 wherein the outer profiled edge extends from the plate surface to create a lip around the plate body, and the portion of the outer profiled edge which is analogous to the profile of the air passage interface extends from the lip, the lip and the outer profiled edge defining the plate edge

7. The ventilation suction member according to claim 1 wherein the portion of the outer profiled edge which is analogous to the profile of the air passage interface extends from the plate surface and the plate edge is defined by an edge of the plate surface and the outer profiled edge.

8. The ventilation suction member according to claim 1 further including an elongate positioning member extending from the plate body and being configured to permit positioning of the ventilation suction member onto the freight container.

9. The ventilation suction member according to claim 8 wherein the elongate positioning member is fluidly connected to the ventilation passage and is configured to permit the passage of air along its length.

10. The ventilation suction member according to claim 8 wherein the elongate positioning member is telescopic.

11. The ventilation suction member according to claim 1 further including an auxiliary attachment member configured to secure the ventilation suction member to the freight container.

12. A ventilation assembly, for ventilating the inside of a freight container, comprising:
a ventilation suction member according to claim 1; and
an air extractor fluidly coupled to the ventilation passage of the ventilation suction member, the air extractor being operable to extract air from inside the freight container via the air passage interface.

13. The ventilation assembly according to claim 12 further including an elongate air conduit secured between the ventilation passage and the air extractor to create an air passage therebetween.

14. The ventilation assembly according to claim 12 further including a vacuum measurement device to monitor a vacuum pressure at the ventilation suction member.

15. A freight container ventilation arrangement comprising:
a ventilation assembly according to claim 12; and
a freight container having an air passage created by openings formed in a portion of a wall of the freight container to define an air passage interface where air is permitted to pass between the inside and outside of the freight container,
the ventilation suction member of the ventilation assembly being selectively suctioned to the freight container at the air passage interface by operating the air extractor and positioning the ventilation suction member at the air passage interface.

16. A method of ventilating an inside of a freight container comprising:
extracting air through a passage formed through a body of a plate;
positioning the plate at an air passage interface of a freight container so that at least a portion of a profile of a plate outer edge is in register with an analogous profile of the freight container at the air passage interface, thereby suctioning the plate to the freight container;
continuing to extract air through the passage of the plate so that air within the freight container is removed from the freight container via openings formed in a wall of the freight container at the air passage interface.

17. The method according to claim 16 wherein the positioning the plate at an air passage interface of a freight container includes positioning the plate directly onto the freight container at the air passage interface, wherein the plate creates a complete seal between the plate and the freight container, thereby suctioning the plate to the freight container.

18. The method according to claim 16 wherein the positioning the plate at an air passage interface of a freight container includes positioning the plate onto the freight container at a position other than that of the air passage interface, wherein the plate creates an incomplete seal between the plate and freight container, and further comprises:
sliding the plate along the wall of the freight container towards the air passage interface until it abuts a frame member of the freight container, abutment to the frame member completing the seal between the plate and the freight container, thereby suctioning the plate to the freight container.

19. The method according to claim 16 further comprising:
measuring a vacuum created at the plate and altering operation of air extraction if the vacuum measurement reaches a predetermined level

20. The method according to claim 16 further comprising:
opening doors of the freight container only after a predetermined amount of time of air extraction.
